(19) United States
(12) Patent Application Publication
(10) Pub. No.: US 2024/0409252 A1
(43) Pub. Date: Dec. 12, 2024

(54) SYSTEM FOR CARRYING OUT WORK PROCESSES ON WORKPIECES OR THE LIKE

(71) Applicant: Robert Bosch GmbH, Stuttgart (DE)

(72) Inventor: Sami Touhent, Moessingen (DE)

(21) Appl. No.: 18/702,936

(22) PCT Filed: Dec. 13, 2022
(86) PCT No.: PCT/EP2022/085663

§ 371 Date: Apr. 19, 2024

(30) Foreign Application Priority Data
Dec. 13, 2021 (DE) 10 2021 214 251.6

(51) Int. Cl. B65B 3/28; B65B 43/54; G01G 17/06

(52) U.S. Cl. CPC B65B 3/28; B65B 43/54; G01G 17/06

(57) ABSTRACT

A system for carrying out work processes on workpieces or the like. The system includes a work surface on which are arranged first transport units which are movable independently of one another by electromagnetic drives and are designed to remove the workpieces or the like from a first conveying device, subsequently to supply them to various process stations, for carrying out the work processes on the workpieces or the like, and finally to transfer the workpieces or the like to a second conveying device after the work processes have been carried out, The process stations include at least one metering device with a metering needle or similar element for dispensing a medium to the workpieces or the like.

### FIELD

The present invention relates to a system for carrying out work processes on workpieces or the like, in which a process station in the form of a metering device serving to dispense a liquid or pasty medium can advantageously be calibrated or checked with a view to the quantity of dispensed medium.

### BACKGROUND INFORMATION

German Patent Application No. DE 10 2014 214 696 A1 describes a system for carrying out work processes on workpieces or the like. The described system is used to fill containers by means of metering devices, wherein the containers are removed from the region of a first conveying device by means of independently movable first transport units driven by electromagnetic drives. After the containers are removed, they are supplied by the first transport units to a metering device and, after dispensing a certain quantity of the medium, are transferred from the first transport units into a second conveying device.

For checking the fill quantities in a metering device, it is also described in U.S. Patent Application Publication No. US 2004/0173284 A1 to arrange calibration stations in the form of weigh stations next to a conveying section for the containers. The metering device is designed to move its filling needles between a first position for dispensing the filling material into the containers in the region of the conveying section and a second position into the region of the calibration stations.

### SUMMARY

A system according to the present invention for carrying out work processes on workpieces or the like may have an advantage that, in connection with metering devices arranged fixedly in the region of the work surface, the system makes it possible to advantageously calibrate and/or check the metering devices with a view to the quantities of liquid or pasty medium dispensed by the metering devices.

According to the present invention, second transport units are used, which are movable independently of the first transport units, to provide the possibility of receiving medium, dispensed by the metering devices, at the location of the metering devices in the region of the work surface and of detecting the quantity of the medium next to the work surface in the region of a weighing device.

Against the background of the above explanations, it is therefore provided in a system according an example embodiment of the present invention for carrying out work processes on workpieces or the like that a weighing device with a measuring cell for weighing a measuring beaker, which can be released from the measuring cell, is arranged next to the work surface, and that at least one second, electromagnetically movable transport unit is additionally designed to transport the measuring beaker between the region of the measuring cell and the region of the metering device.

Advantageous developments and example embodiments of the system according to the present invention for carrying out work processes on workpieces or the like are disclosed herein.

With a view to a universal usability of the second transport unit for carrying out different processes secondary to the main processes, according to an example embodiment of the present invention, it is particularly preferred if the at least one second transport unit is designed to transport other objects as an alternative to the measuring beaker into the region of a process station.

In a preferred development of such a universally usable second transport unit according to the preent invention, it is in particular provided that the at least one second transport unit has a receiving device with at least one standardized interface for the different objects.

In order during the actual operation of the system to keep the region of the work surface free for the first transport units or to form transport surfaces as large as possible for the first transport units, it is provided that the at least one second transport unit is arranged in a provision zone in the region of the work surface when not in use. This provision zone is typically spaced apart from an edge region of the work surface that is commonly used by the first transport units when transporting workpieces or the like.

In a preferred structural design of the weighing device, the weighing device comprises a lifting element for releasing the measuring beaker from the load cell and for transferring and taking over the measuring beaker to and from the second transport unit.

In order to achieve as accurate a weighing result as possible, it is also advantageous if the load cell is arranged (mechanically) decoupled from the work surface. This prevents the transmission of vibrations, impacts, or similar influences distorting the measurement result of the load cell.

In particular, according to an example embodiment of the present invention, it is provided that the system comprises metering devices whose metering needles are arranged fixedly relative to the plane of the work surface, wherein the metering needle is arranged so as to be liftable and lowerable separately or together with the metering device in a direction perpendicular to the plane of the work surface.

In order to allow for the most automatic calibration or weighing possible without the need for manual interventions or an operator, it is also provided in an advantageous configuration of the weighing device that the weighing device comprises an elimination and supply device for measuring beakers. The discharge and supply device serves to convey, after the weighing, a measuring beaker, filled with the medium, from the region of the load cell or the weighing device and to replace it with a new, previously unused measuring beaker, which can subsequently be transported by the second transport unit into the region of the metering device for a further weighing process.

According to an example embodiment of the present invention, in order to form the lowest possible number of different transport units, it is also advantageous if the at least one second transport unit can be formed by fitting a first transport unit with a conversion kit. In other words, this means that a first transport unit can be converted to a second transport unit and a second transport unit can be converted to a first transport unit.

Furthermore, the present invention also comprises a method for carrying out a weighing process in a system according to the present invention described thus far. According to an example embodiment of the present invention, the method includes at least the following steps: First, a second transport unit transports a measuring beaker from the region of the weighing device into the region of the metering device. The metering device subsequently dispenses a target quantity of medium into the measuring beaker. Then, the measuring beaker filled with the medium is transported into the region of the weighing device. Subsequently, the measuring beaker is placed on the load cell of the weighing device and the measuring beaker is released from the second transport unit. Subsequently, the actual quantity of medium in the measuring beaker is measured by means of the load cell. Finally, where appropriate, the medium-filled measuring beaker is disposed of from the region of the weighing device, and an unfilled measuring beaker is provided. The disposal of the measuring beaker after the weighing process can take place either after each weighing process or preferably (only) when the measuring beaker is full. In the latter case, the currently detected actual quantity can take place by taking into account the masses of the medium already detected in the measuring beaker from the last weighing processes.

Further advantages, features and details of the present invention become apparent from the following description of preferred embodiments of the present invention and from the figures.

### BRIEF DESCRIPTION OF THE DRAWINGS

FIG. 1 shows, in a simplified representation, an apparatus for carrying out work processes on workpieces or the like according to an example embodiment of the present invention.

FIG. 2 to FIG. 11 each show, in a simplified side view, the region of a weighing device while a weighing process is carried out at a metering device, according to an example embodiment of the present invention.

### DETAILED DESCRIPTION OF EXAMPLE EMBODIMENTS

Identical elements or elements with the same function are provided with the same reference signs in the figures.

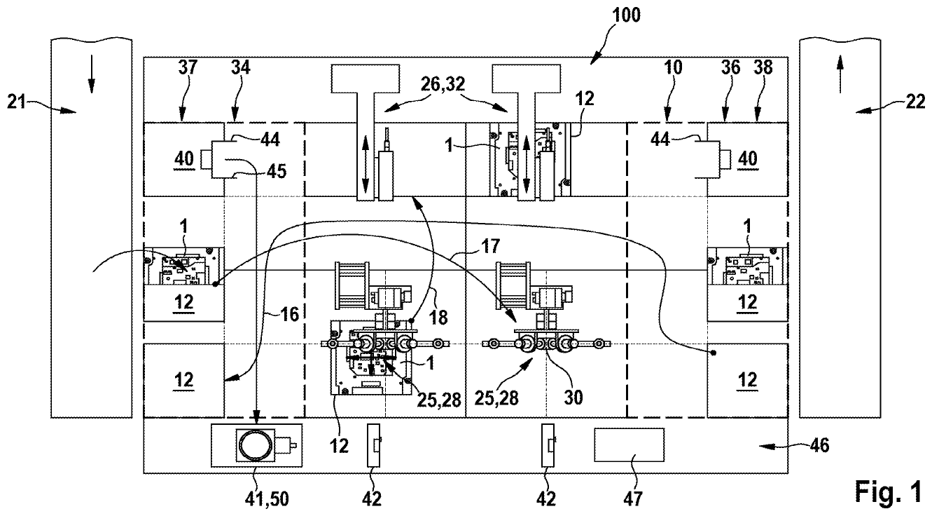

FIG. 1 is a highly simplified representation of a system 100 for carrying out work processes on workpieces 1 or the like. The workpieces 1 may, for example, be housing parts or the like, which are to be provided by means of the system 100 in a local or defined region with a pasty medium M for sealing the housing parts or for dissipating heat or similar purposes.

The system 100 comprises a work surface 10, which is arranged horizontally, wherein a plurality of first transport units 12, so-called movers, is located on the work surface 10. The first transport units 12 are controllable individually by a control device (not shown in the figures), wherein the first transport units 12 are arranged so as to be freely movable on the work surface 10. For this purpose, electromagnetic drives (not shown in detail) are used, which allow the first transport units 12 to execute any first conveying paths 16 to 18.

By way of example, the first transport units 12 serve to transport a respective workpiece 1 or the like in the region of the work surface 10. The workpieces 1 or the like are supplied to the system 100 laterally of the work surface 10 by means of a first conveying device 21, which is only shown symbolically and is preferably designed in the form of a linear conveyor, such as a chain conveyor, a belt conveyor, or the like. After carrying out work processes in the region of the system 100, the (processed) workpieces 1 or the like are transported away from the region of the work surface 10 or of the system 100 by means of a second conveying device 22, which is arranged on the side of the work surface 10 opposite the first conveying device 21 and is likewise shown purely symbolically. The second conveying device 22 is preferably likewise designed in the form of a linear conveyor.

By means of gripping devices or similar devices (not shown), the workpieces 1 or the like can be removed from the first conveying device 21 and placed on the first transport units 12. Likewise, after the work processes have been carried out, the gripping devices or the like (not shown) serve to lift the workpieces 1 or the like from the first transport units 12 and to supply them to the second conveying device 22.

For carrying out the work processes by means of the system 100, said system has, by way of example, two first process stations 25 and two second process stations 26 in the region of and, optionally, above the work surface 10. The first process stations 25, which are arranged laterally next to one another, are each designed as so-called dispensing stations with a metering device 28 for dispensing the medium M, which metering device is fixedly arranged in the plane of the work surface 10 and in each case comprises a metering needle 30 arranged so as to be liftable perpendicularly to the plane of the work surface 10. For example, the second process stations 26 are test devices 32 in the form of cameras or similar devices, which are used to monitor the work processes carried out by the first process stations 25 or to check them for proper execution.

The work surface 10 has, in each case laterally next to the process stations 25 and 26, a first and a second provision zone 34, 36, each marked with a dashed border, in the region of which first transport units 12 can be arranged. Furthermore, the provision zones 34 and 36, which are rectangular by way of example, serve, in particular in the region of waiting zones 37, 38, to receive at least one second transport unit 40 or to park it there.

While the first transport units 12 serve to supply the workpieces 1 or the like to the process stations 25, 26 so that so-called main processes (referred to above as work processes) can run there, the second transport units 40 serve to be able to carry out secondary processes that are independent of the main processes in terms of time and/or location. The secondary processes include, for example, the calibration, checking, or cleaning of the process stations 25, 26 by means of at least one test device 41, calibration device 42, or cleaning device 47 in each case. The test device 41, calibration device 42, and cleaning device 47 are arranged, by way of example, in a strip-shaped region 46 next to the work surface 10. In the exemplary embodiment, a test device 41 is designed in the form of a weighing device 50.

The second transport unit 40 comprises a fork-shaped receiving device 44, which is designed in the form of an interface 45, for carrying out different secondary processes or for handling different objects required for carrying out the secondary processes. In particular, first transport units 12 and second transport units 40 can each be converted or retrofitted into one another by means of a conversion kit.

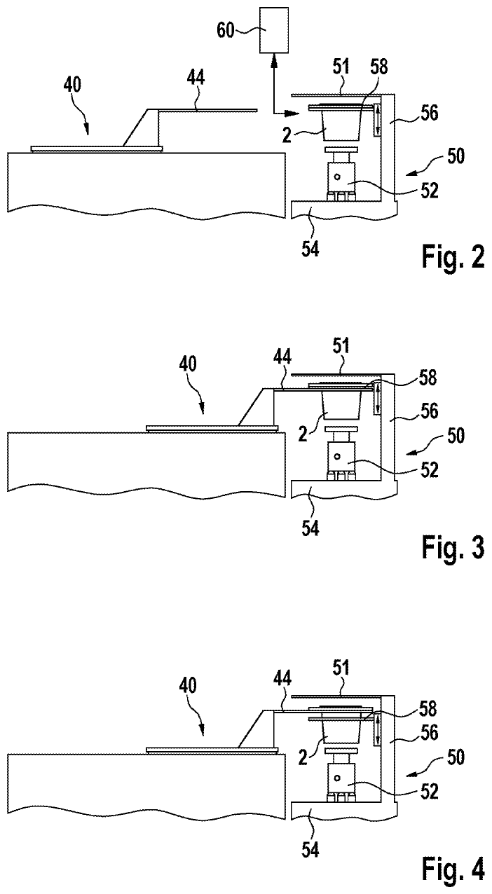

As can be seen in FIGS. 2 to 11, the weighing device 50 covered by a cover 51 comprises a measuring cell 52, which is arranged in the region of a base 54. The base 54 is preferably arranged mechanically decoupled from the work surface 10 in order to prevent vibrations, impacts, or the like from being transmitted to the measuring cell 52. Furthermore, the weighing device 50 comprises a carrier device 56 with a liftable and lowerable, by way of example fork-shaped, lifting element 58, in the region of which a measuring beaker 2 can be arranged or can be lifted or lowered by the lifting element 58.

Additionally, it is in particular provided that the weighing device 50 cooperates with a changing device 60, which is not shown in detail and is therefore only symbolically shown. The changing device 60 serves to discharge, after at least one weighing process, a measuring beaker 2, which is arranged in the region of the measuring cell 52 and filled with a medium M, from the region of the weighing device 50 and subsequently to supply a new unfilled measuring beaker 2 to the weighing device 50 in order to be able to carry out a further weighing process. However, the measuring beaker 2 is preferably only exchanged when it is nearly completely filled with medium M (from previous weighing processes).

In addition, it is mentioned that, instead of a changing device 60, it may also be provided to discharge or supply a measuring beaker 2 by means of the second transport unit 40.

It is furthermore mentioned that, according to the representation of FIG. 6, the metering needle 30 of the metering device 28 is arranged so as to be liftable and lowerable according to the direction of the double arrow 62, while the metering device 28 is otherwise arranged fixedly with a view to its position relative to the plane of the work surface 10.

Before starting the operation of the system 100, after a certain number of metering processes, or else after completing the operation of the system 100, the weighing device 50 serves to weigh a target quantity of liquid or pasty medium M dispensed by the metering device 28 via the metering needle 30 thereof, in order to be able to deduce a correct quantity or mass of the medium M during operation of the system 100. For this purpose, the functional principle of the system 100 with a view to the weighing device 50 is explained as follows with reference to the sequence of FIGS. 2 to 11:

According to FIG. 2, a second transport unit 40 is first moved out of the region of the provision zone 34, for example, into the region of the weighing device 50. For this purpose, it is in particular provided that the metering needle 30 or the metering device 28 are initially arranged in a raised position such that the second transport unit 40 can be moved below the metering device 28 without colliding with the metering device 28 and the metering needle 30 thereof. Furthermore, it can be seen in FIG. 2 that the lifting element 28 has lifted a measuring beaker 2 (which is, by way of example, unfilled) into a raised position spaced apart from the measuring cell 52.

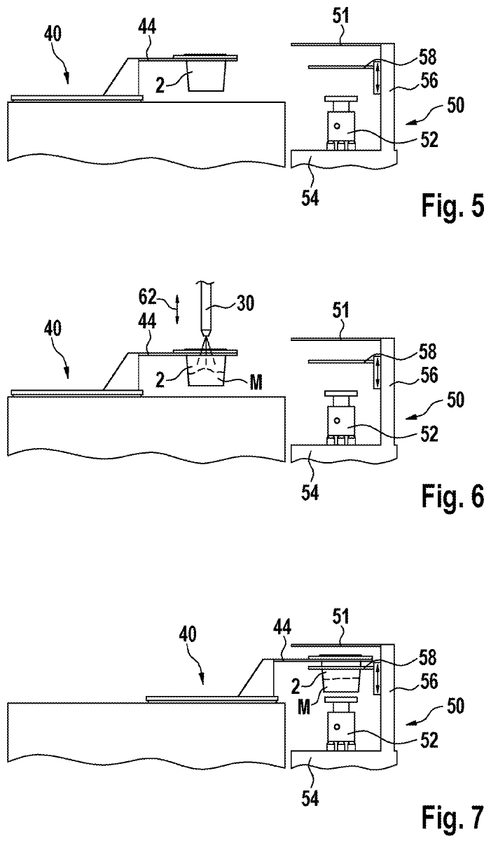

Subsequently, according to the representation of FIG. 3, the measuring beaker 2 is taken over by the second transport unit 40 by bringing the holding device 48 into contact with the measuring beaker 2. Thereafter, according to FIG. 4, the lifting element 58 is lowered in order to release the measuring beaker 2 from the lifting element 58. Subsequently, according to FIG. 5, the measuring beaker 2 is moved from the region of the weighing device 50 by the second transport unit 40 and is positioned according to FIG. 6 below the metering needle 30 of the metering device 28.

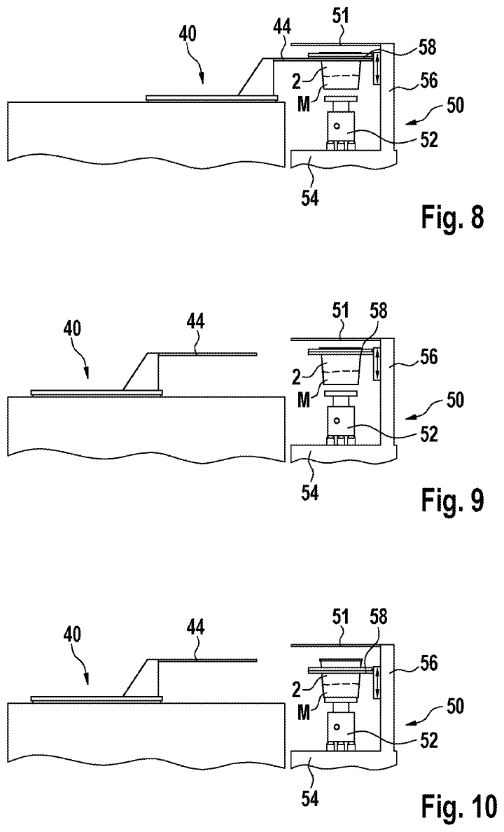

With the metering needle 30 lowered where appropriate, the metering device 28 subsequently dispenses the target quantity of medium M to the measuring beaker 2. Subsequently, according to FIG. 7, the measuring beaker 2, which is now filled with the medium M, is transported back into the region of the weighing device 50. In so doing, medium M can be wiped off the metering needle tip beforehand by wiping the beaker edge of the measuring beaker 2 on the metering needle tip. This is made possible by the highly accurate movement of the measuring beaker 2 by means of the second transport unit 40. For the lifting element 58 of the carrier device 56 taking over the measuring beaker 2 from the second transport unit 40, the lifting element 58 is subsequently lifted according to FIG. 8 so that it comes into contact with the measuring beaker 2. If this has taken place, the second transport unit 40 is removed according to the representation of FIG. 9 from the region of the weighing device 50.

Then, according to FIG. 10, the lifting element 58 is lowered with the measuring beaker 2 in order to lower the measuring beaker 2 onto the measuring cell 52. The lowering takes place such that the lifting element 58 places the measuring beaker 2 on the measuring cell 52, wherein contact between the measuring beaker 2 and the lifting element 58 no longer exists. In this position, the weighing device 50 or the measuring cell 52 carries out the measuring process in order to check whether the actual quantity of medium M dispensed into the measuring beaker 2 corresponds to the target quantity M. The result is used to calibrate or adjust the metering device 28.

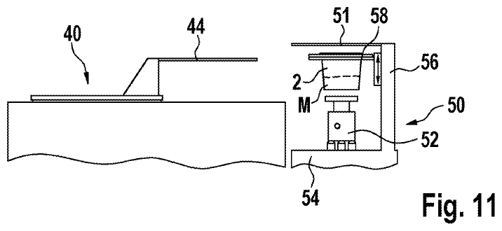

Finally, according to FIG. 11, it is provided that the lifting element 58 re-releases the measuring beaker 2 from the measuring cell 52. In this position, for example, the (partially or completely) filled measuring beaker 2 can be disposed of by the changing device 60 and be replaced by a new unfilled measuring beaker 2.

The system 100 described thus far can be altered or modified in many ways without deviating from the scope of the present invention.

1-10 (canceled).

11. A system for carrying out work processes on workpieces, comprising:
a work surface on which are arranged first transport units which are movable independently of one another by electromagnetic drives and are configured to remove the workpieces from a first conveying device, subsequently to supply the removed workpieces to various process stations for carrying out the work processes on the workpieces, and to transfer the workpieces to a second conveying device after the work processes have been carried out, wherein the process stations include at least one metering device configured to dispense a medium to the workpieces;
a weighing device with a measuring cell for weighing a measuring beaker, which can be released from the measuring cell, is arranged next to the work surface; and
at least one second, electromagnetically movable transport unit configured to transport the measuring beaker between a region of the measuring cell and a region of the metering device.

12. The system according to claim 11, wherein the meter device includes a metering needle.

13. The system according to claim 11, wherein the at least one second transport unit is configured to transport other objects as an alternative to the measuring beaker to the region of a process station.

14. The system according to claim 13, wherein the at least one second transport device includes a receiving device with at least one standardized interface for other objects.

15. The system according to claim 11, wherein the at least one second transport unit is arranged in a provision zone in a region of the work surface when not in use.

16. The system according to claim 11, wherein the weighing device includes a lifting element for releasing the measuring beaker from the measuring cell and for transferring and taking over the measuring beaker to and from the second transport unit.

17. The system according to claim 11, wherein the measuring cell is arranged mechanically decoupled from the work surface.

18. The system according to claim 11, wherein the metering device with a metering needle is arranged fixedly relative to a plane of the work surface, and in that the metering needle is arranged so as to be liftable and lowerable separately or together with the metering device in a direction perpendicular to the plane of the work surface.

19. The system according to claim 11, wherein a changing device for measuring beakers is assigned to the weighing device.

20. The system according to claim 11, wherein the at least one second transport unit is formable by fitting a first transport unit with a conversion kit.

21. A method for carrying out a weighing process of a medium in a system, the system including:
a work surface on which are arranged first transport units which are movable independently of one another by electromagnetic drives and are configured to remove the workpieces from a first conveying device, subsequently to supply the removed workpieces to various process stations for carrying out the work processes on the workpieces, and to transfer the workpieces to a second conveying device after the work processes have been carried out, wherein the process stations include at least one metering device configured to dispense a medium to the workpieces,
a weighing device with a measuring cell for weighing a measuring beaker, which can be released from the measuring cell, is arranged next to the work surface; and
at least one second, electromagnetically movable transport unit configured to transport the measuring beaker between a region of the measuring cell and a region of the metering device;
the method comprising the following steps:
transporting a first measuring beaker from a region of the weighing device into the region of the metering device using the second transport unit;
dispensing a target quantity of medium into the first measuring beaker using the metering device;
transporting the first measuring beaker, filled with the medium, into the region of the weighing device;
placing the measuring beaker on the measuring cell of the weighing device and releasing the measuring beaker from the second transport device;
measuring an actual quantity of medium using the measuring cell;
disposing of the measuring beaker, filled with the medium, from the region of the weighing device and providing an unfilled measuring beaker.
